(19) United States
(12) Patent Application Publication
(10) Pub. No.: US 2008/0209461 A1
(43) Pub. Date: Aug. 28, 2008

(54) Small Cartridge Free Optical Disc With High Level of Redundancy and Tolerance For Missing Data

(75) Inventors: Mark Thomas Johnson, Veldhoven (NL); Wilhelmus Franciscus Johannes Fontijn, Eindhoven (NL); Anthonie Hendrik Bergman, Nuenen (NL); Steven Broeils Luitjens, Eindhoven (NL); Guofu Zhou, Best (NL); Michael Adrianus Henricus Van Der Aa, Sint Michelsgeste (NL); Frank Cornelis Penning, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/994,244

(22) PCT Filed: Jun. 27, 2006
(86) PCT No.: PCT/IB06/52117

§ 371 Date: Dec. 28, 2007

Related U.S. Application Data
(60) Provisional application No. 60/695,661, filed on Jun. 30, 2005.

(51) Int. Cl. G11B 7/24

(52) U.S. Cl. 720/718

(57) ABSTRACT

In the invention, e-book information is distributed on un-cartridged small media that can be made cheaply enough for use in free distribution of information. The e-book information is encoded and stored on a read-only optical disc that is 2 to 4 cm in diameter and 0.6 to 1.2 mm thick, the information being encoded with sufficient redundancy and sufficient tolerance for missing information that the disc can be conveniently handled and pocketed without losing reliability of information access. The disc has a lead-in area that is prior to all the e-book information and that contains a disc navigation area, and a lead-out area that follows all the e-book information. The disc may include multiple partitions, each partition containing sufficient access information for independent access of the e-book information within the partition without accessing any other partition. Alternatively, the disc may include multiple slots for files and that are equally spaced. For example, to provide data redundancy, at least some of the partitions are duplicate partitions that contain all the same data as another duplicate partition, and the disc navigation area contains partition descriptors that indicate all the partitions and the areas allocated to each of the partitions, and the disc also includes duplicates of the partition descriptors, the duplicate partition descriptors being stored in the lead-in area or in the lead-out area to provide redundancy of navigation information.

The invention herein relates to the field of read only optical media for distribution of free e-books.

Today, newspapers (Metro, Spits etc.) are distributed free for commuters. Some CD's containing software such as the AOL browser have been distributed for free.

However, the cost of CD media and packaging necessary to protect the media, has been too expensive in relation to the cost of newspapers to justify distributing free e-books using CD media.

Those skilled in the art are directed to the following citations:

Publication US2002/0112172 by Simmons discloses distribution of e-books on a mini-disc.

Patent EP0599765 by Anderson et. al. discloses redundant information on a magnetic disc drive.

The above citations are hereby incorporated herein in whole by reference for background purposes.

In the invention herein, a low-cost, low-fidelity small disc media is used for distribution of free e-books. The disc has no protective cartridge so it is subject to scratching and fingerprints as it is pocketed and handled so it is expected that there will be a very high read error rate. The disc provides for massive data redundancy and tolerance for lost data in order to maintain reliability.

In a method of distributing an e-book, the e-book information is encoded and stored on windings of a spiral track or circular tracks of a read-only optical disc that is 2 to 4 cm in diameter and 0.6 to 1.8 mm thick. The information is encoded with sufficient redundancy and sufficient tolerance for missing information that the disc can be handled and pocketed without losing reliability of information access. Then the disc is distributed un-cartridged to the public for free. The disc may be about 3 cm in diameter and about 1.2 mm thick.

The level of redundancy of the information on the disc may be higher than 2 in order to maintain reliability. The redundancy may include a duplicate copy of the e-book information on the disc and simultaneously scanning the duplicate information when reading the disc.

The tolerance for missing information may be provided using uncompressed bit-maps for pictures and/or text so that missing data can be easily tolerated. In addition or alternatively, The tolerance for missing information may be provided using sequences of uncompressed text character codes so that missing data can be easily tolerated. The tolerance for missing information may be provided for video clips by including repeated sequences of sector aligned packets in an MPEG video stream.

In another aspect of the invention, a highly redundant and missing information tolerant format is provided for the disc by using duplicate partitions. The read only optical disc may comprise a substrate that is 2 to 4 cm in diameter and 0.6 to 1.8 mm thick for user convenience in pocketing and handling the disc. At least one data layer of the substrate contains an area of predetermined embossed windings of spiral or circular tracks and marks embossed on the winding and representing the information. The area of the disc layer is divided up into multiple partitions to which the windings are allocated, each partition contains sufficient access information for independent access of the data within the partition without accessing any other partition. At least some of the partitions are duplicate partitions that contain all the same data as another duplicate partition The disc also includes a lead-in area that is prior to any partitions in a normal scanning direction and that contains a disc navigation area that contains partition descriptors that indicate all the partitions and the areas allocated to each of the partitions. The disc also includes a lead-out area following the last partition.

The data in the lead-out area may include at least one duplicate of each of the different partition descriptors in the lead-in area. The lead-in area may include at least one duplicate of each of the different partition descriptors in the lead-in area.

The duplicate data should be separated to reduce the risk that both copies of the data could be damaged by the same scratch, nick, dent, dirt spot. A pair of duplicate partitions that contain all the same data may be separated by other partitions so that respective areas of the pair of duplicate partitions are not adjacent. Also, a partition may consist of multiple different areas of the disc and the multiple areas of the partition may be interleaved with multiple areas of other partitions to separate copies of the same data.

The duplicate partitions may contain multiple files and directory information for accessing the files, and the files may consist of multiple segments that are interleaved with segments of other files.

In another aspect of the invention, a highly redundant and missing information tolerant information format is provided for the disc by using duplicate files. The optical disc includes multiple slots for containing respective data files, each slot defining one or more areas in which the respective data file is stored, at least some of the slots being duplicate slots that each contain the same data file as another duplicate slot. A lead-in area that is prior to any slots in a normal scanning direction and that contains a disc navigation area that contains slot descriptors that indicate all the slots and at least the position of the beginning of each slot. A lead-out area follows the last file slot on the disc.

The positions of the beginning of the slots may be all equally spaced on the disc. Also, the positions of the beginnings of the slots may be all defined by the same indication of the spacing between beginnings of slots, the indication of spacing being contained in the disc navigation area.

The above described optical discs have high redundancy and tolerance of missing data and may be used in an optical system to provide sufficient reliability in the presence of high error rates and missing data. The system may include an optical disc substrate about 2 to 4 cm in diameter and about 0.6 to 1.8 mm thick. The substrate has at least one layer that contains an area of predetermined embossed windings of spiral or circular tracks and the windings contain embossed marks representing the information. A caddy is provided for holding the disc, and the caddy is openable for replacing the disc. The optical system also includes a scanning unit for spinning the disc and scanning the spinning disc with a laser to read data from the disc when the disc is inserted into the caddy and the caddy is inserted into the scanning unit. The scanning unit may be incorporated in a player with speakers and a display.

These and other aspects of the invention will be apparent to those skilled in the art from the following detailed description of the invention with reference to the following drawings.

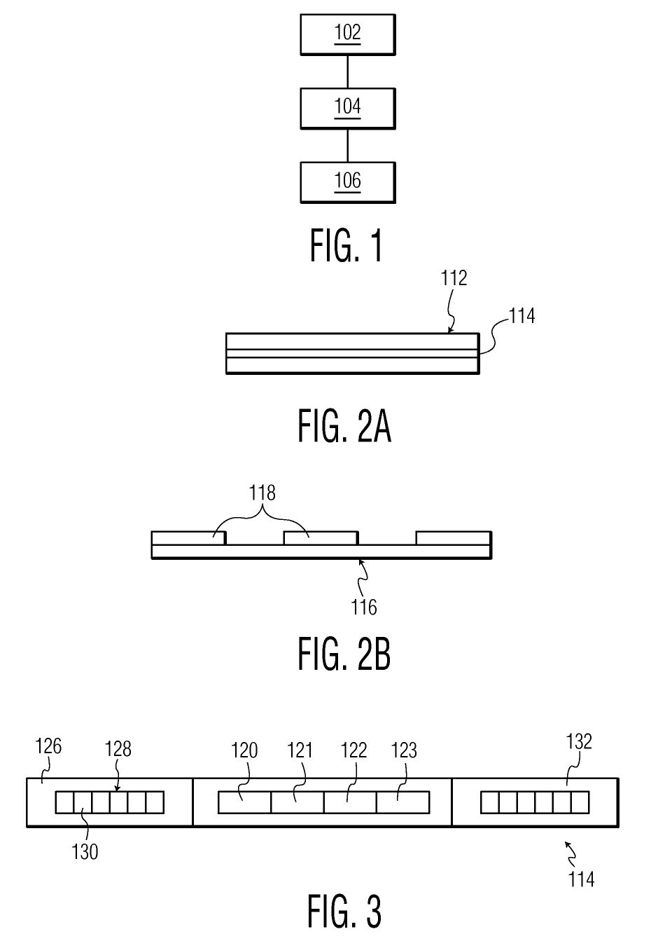

FIG. 1 is a flow diagram describing a specific embodiment of the method of the invention for providing e-books.

FIGS. 2a and 2b illustrate a specific example of an optical disc of the invention.

FIG. 3 shows the format of an information layer of the optical disc of FIG. 2.

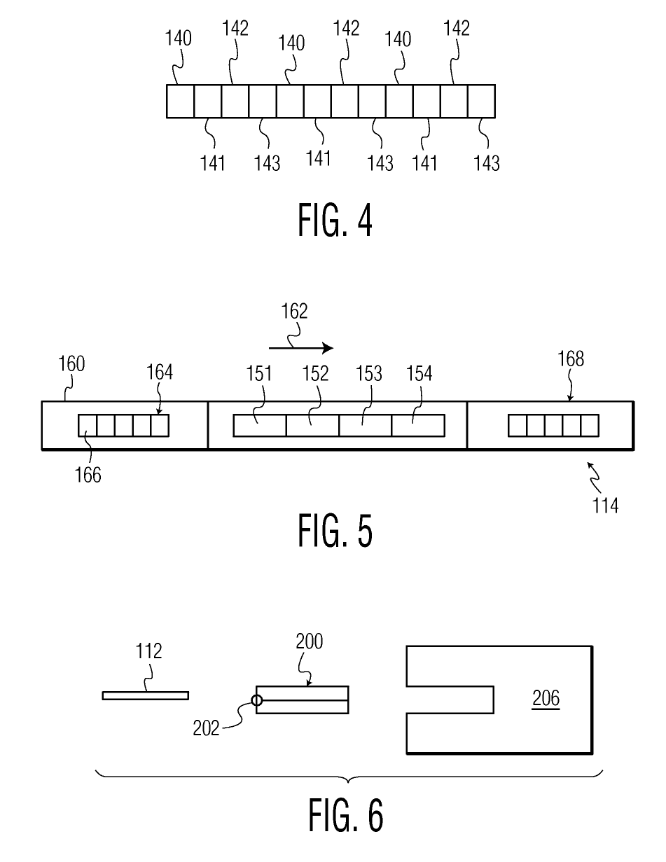

FIG. 4 illustrates a specific example of the layout of the information layer of FIG. 3, including a lead-in area, a lead-out area, and duplicate partitions that are interleaved.

FIG. 5 illustrates another embodiment of the information layer of FIG. 3 in which the windings are allocated into multiple slots.

FIG. 6 shows a system of the invention for playing the disc of FIG. 2.

In FIG. 1, flow diagram 100 illustrates an example embodiment of the method of the invention herein for distributing e-book information. In step 102, the e-book information is encoded and in step 104 the encoded e-book information is stored on windings of a spiral track or circular tracks of a read-only optical disc that is 2 to 4 cm in diameter and 0.6 to 1.2 mm thick, the information being encoded with sufficient redundancy and sufficient tolerance for missing information that the disc can be handled and pocketed without losing reliability of information access. Then in step 106 the discs are distributed un-cartridged to the public for free.

The distribution of e-book information for free to the public requires that the disc be produced at a very low cost. Thus, a disc contained in a cartridge (such as an SFFD) can not be used. Because the disc is not protected the disc has to provide massive redundancy and tolerance for missing data.

The disc may be about 3 cm in diameter and about 1.2 mm thick which is a convenient size to store in a pocket of clothing. The level of redundancy should be higher than 2 and may be as high as 10. The redundancy may include a duplicate copy of the information on the disc and the information and duplicate copy may be simultaneously scanned when reading the disc. The encoded information may include multiple uncompressed bit-maps so that missing data can be easily tolerated. Both pictures and text may be stored as bit-maps. The information may include sequences of uncompressed text character codes so that missing data can be easily tolerated. For example ASCII codes can be used for storing text. MPEG video clips may also be included with redundancy provided by repeated sequences of sector aligned packets.

FIGS. 2a and 2b illustrate a specific example of an optical disc 110 of the invention. The optical disc includes a substrate 112 that is 2 to 4 cm in diameter and 0.6 to 1.8 mm thick. At least one information layer 114 within the substrate of the disc contains an area of predetermined embossed windings 116 of spiral or circular tracks and embossed marks 118 on the windings representing information.

FIG. 3 shows the format of an information layer 114 of optical disc 112 in FIG. 2a. The windings are allocated into multiple partitions 120, 121, 122, 123. Each partition contains sufficient access information for independent access of the data within the partition without accessing any other partition. At least some of the partitions are duplicate partitions that contain all the same data as another duplicate partition. Here partition 120 and 122 are duplicates and partitions 121 and 123 are duplicates.

The windings also include a lead-in area 126 that is prior to any partitions in a normal scanning direction and that contains a disc navigation area 128 that contains partition descriptors 130 that indicate all the partitions and the areas allocated to each of the partitions. The windings also include a lead-out area 132 following the last partition.

Data in the lead-out area may include at least one duplicate of each of the different partition descriptors in the lead-in area. The lead-in area also may include at least one duplicate of each of the different partition descriptors in the lead-in area.

The optical disc may be about 3 cm in diameter and about 1.2 mm thick for convenient user handling and storage is user pockets.

The optical disc may include a pair of duplicate partitions that contain all the same data and that are separated from each other by other partitions so that respective areas of the pair of duplicate partitions are not adjacent.

In FIG. 4 the partitions are divided up into multiple areas that are interleaved with the multiple partitions of other partitions. In FIG. 4 partition 140 consists of three areas that are interleaved with portions of other partitions 141, 142 and 143.

The data in the partitions is encoded with means to provide both data redundancy and tolerance for missing data. Data redundancy can be achieved by providing multiple copies of all the data on the disc and/or by ECC encoding of the data. Tolerance for missing data may be achieved by storing the data uncompressed or in small compressed portions and by encoding the data in fault tolerant formats such as storing text and pictures as bit-maps so that even if lots of data is missing, enough of the bit-map data may still be able to be displayed for human understanding of the data.

The duplicate partitions may each contain multiple files and directory information for accessing the files and the files may consist of multiple segments that are interleaved with segments of other files in a manner similar to the way partitions are interleaved in FIG. 4.

FIG. 5 illustrates another embodiment of the information layer 114 of optical disc 112 in which the windings are allocated into multiple slots 151, 152, 153 and 154 for containing respective data files. Each slot defines one or more areas in which the respective data file is stored. At least some of the slots are duplicate slots that contain the same data file as another duplicate slot. Lead-in area 160 is prior to any slots of the disc in a normal scanning direction 162. The lead-in contains a disc navigation area 164 that contains slot descriptors 166 that indicate all the slots and at least the position of the beginning of each slot. Winding of the information layer windings are also allocated to a lead-out area 168 following the last slot of the information layer.

The slots may have beginnings that are all equally spaced on the disc so that the beginning positions of all the slots can be defined by the same indication of the spacing between beginnings of slots and the indication of spacing can be provided in the disc navigation area 164.

FIG. 6 shows a system for playing the disc of FIG. 2a. The system includes the optical disc 112 of FIG. 2a as described above. The system also includes a caddy 200 for holding the disc, the caddy being openable for replacing the disc. The caddy may have a hinge 202 for opening the caddy so that the disc can be inserted into and removed from the caddy. The playing system also includes scanning unit 206 for spinning the disc and scanning the disc with a laser beam to read data from the disc when the disc is inserted into the caddy and the caddy is inserted into the scanning unit.

Although this invention has been described with reference to particular embodiments, it will be appreciated that many variations will be resorted to without departing from the spirit and scope of this invention as set forth in the appended claims.

The specification and drawings are accordingly to be regarded in an illustrative manner and are not intended to limit the scope of the appended claims.

In interpreting the appended claims, it should be understood that:

a) the word “comprising” does not exclude the presence of other elements or acts than those listed in a given claim;
b) the word “a” or “an” preceding an element does not exclude the presence of a plurality of such elements;
c) any reference signs in the claims do not limit their scope;
d) several “means” may be represented by the same item or hardware or software implemented structure or function;
e) any of the disclosed elements may be comprised of hardware portions (e.g., including discrete and integrated electronic circuitry), software portions (e.g., computer programming), and any combination thereof;
f) hardware portions may be comprised of one or both of analog and digital portions;
g) any of the disclosed devices or portions thereof may be combined together or separated into further portions unless specifically stated otherwise; and
h) no specific sequence order of acts is intended to be required unless specifically indicated.

We claim:

1. A method of distributing e-book information:
encoding the e-book information;
storing the encoded e-book information on windings of a spiral track or circular tracks of a read-only optical disc that is 2 to 4 cm in diameter and 0.6 to 1.2 mm thick, the information being encoded with sufficient redundancy and sufficient tolerance for missing information that the disc can be handled and pocketed without losing reliability of information access;
distributing the discs un-cartridged to the public for free.

2. The method of claim 1 wherein the disc is about 3 cm in diameter and about 1.2 mm thick.

3. The method of claim 1 wherein the level of redundancy is higher than 2.

4. The method of claim 1 wherein the redundancy includes a duplicate copy of the information on the disc and the information and duplicate copy are simultaneously scanned when reading the disc.

5. The method of claim 1 wherein the information includes multiple uncompressed bit maps so that missing data can be easily tolerated.

6. The method of claim 1 wherein the information includes sequences of uncompressed text character codes so that missing data can be easily tolerated.

7. The method of claim 1 wherein the stored information includes an MPEG video stream with repeated sequences of sector aligned packets.

8. An optical disc comprising:
a substrate that is 2 to 4 cm in diameter and 0.6 to 1.8 mm thick;
at least one information layer containing an area of predetermined embossed windings of spiral or circular tracks and embossed marks on the winding representing information;
multiple partitions to which the windings are allocated, each partition containing sufficient access information for independent access of the data within the partition without accessing any other partition, at least some of the partitions being duplicate partitions that contain all the same data as another duplicate partition;
a lead-in area that is prior to any partitions in a normal scanning direction and that contains a disc navigation area that contains partition descriptors that indicate all the partitions and the areas allocated to each of the partitions;
a lead-out area following the last partition.

9. The optical disc of claim 8 wherein the data in the lead-out area includes at least one duplicate of each of the different partition descriptors in the lead-in area.

10. The optical disc of claim 8 wherein the lead-in area includes at least one duplicate of each of the different partition descriptors.

11. The optical disc of claim 8 wherein the disc is about 3 cm in diameter and about 1.2 mm thick.

12. The optical disc of claim 8 wherein a pair of duplicate partitions that contain all the same data are separated from each other by other partitions so that respective areas of the pair of duplicate partitions are not adjacent.

13. The optical disc of claim 8 wherein a partition consist of multiple different areas of the disc and the multiple areas of the partition are interleaved with multiple areas of other partitions.

14. The optical disc of claim 8 wherein, the data in the partitions is encoded with means to provide both data redundancy and tolerance for missing portions of data.

15. The optical disc of claim 8 wherein, the duplicate partitions contain multiple files and directory information for accessing the files and the files consist of multiple segments that are interleaved with segments of other files.

16. An optical disc comprising:
a substrate that is 2 to 4 cm in diameter and 0.6 to 1.8 mm thick;
at least one layer containing an area of predetermined embossed windings of spiral or circular tracks and embossed marks representing information;
multiple slots for containing respective data files, each slot defining one or more areas in which the respective data file is stored, at least some of the slots being duplicate slots that contain the same data file as another duplicate slot;
a lead-in area that is prior to any slots of the disc in a normal scanning direction and that contains a disc navigation area that contains slot descriptors that indicate all the slots and at least the position of the beginning of each slot;
a lead-out area following the last slot of the disc.

17. The optical disc of claim 16 wherein:
the positions of the beginning of the slots are all equally spaced on the disc;
the positions of the beginnings of the slots are all defined by the same indication of the spacing between beginnings of slots, the indication of spacing being contained in the disc navigation area.

18. A system comprising:
an optical disc about 2 to 4 cm in diameter and about 0.6 to 1.8 mm thick, the substrate having at least one layer containing an area of predetermined embossed windings of spiral or circular tracks and embossed marks representing information;
a caddy for holding the disc, the caddy being openable for replacing the disc;
a scanning unit for spinning the disc and scanning the disc with a laser to read data from the disc when the disc is inserted into the caddy and the caddy is inserted into the scanning unit.
